(19) United States
(12) Patent Application Publication
(10) Pub. No.: US 2007/0113469 A1
(43) Pub. Date: May 24, 2007

(54) Liquid cooled floral display

(76) Inventor: Randolph J. Primozic, Willoughby Hills, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/603,914

(22) Filed: Nov. 22, 2006

Related U.S. Application Data
(60) Provisional application No. 60/739,598, filed on Nov. 23, 2005.

(51) Int. Cl. A01G 5/00; A47G 7/02

(52) U.S. Cl. 47/41.01

(57) ABSTRACT

A self-contained floral display unit which allows 360 degree access to the flowers displayed therein, which efficiently cools water in vases containing the flowers using a closed-loop system, which is self contained and easily movable.

### CROSS-REFERENCE

The present application claims priority to and benefit of U.S. Provisional Application, Ser. No. 60/739,598, filed Nov. 23, 2005, which is herein incorporated by reference in its entirety.

### FIELD OF THE INVENTION

The invention is related to a refrigerated display for cut flowers or other merchandise. More specifically, the invention is related to a floral display case which effectively and efficiently chills containers, such as vases, for storage and display of flowers which may be self contained and portable or may be remote refrigerated for stationary applications, and which may be used in an entirely “open air” environment.

### BACKGROUND OF THE INVENTION

Refrigerated display cases are frequently used in markets for presenting merchandise that must be kept cold, such as flowers. In the case of floral merchandisers or display cabinets, there have been a number of open refrigerated display cases proposed, representative examples of which appear in U.S. Pat. Nos. 4,608,835, 4,608,776, 4,680,942, and 4,953,363 among others. Most of these patents disclose a cabinet containing refrigeration equipment for chilling the air that circulates around the flowers, and include either a door or an open display portion for allowing consumer access thereto. The open display portion generally contains vases or containers that are seated in openings or receptacles in shelves.

In the prior art display cases described above, the return air intake grating, being positioned at the base and at the inside of the cabinet, sometimes collects flower petals, dead leaves and other debris, which can affect the operation of the unit, and which may require special cleaning. Additionally, the prior art display cases that include doors which must be opened in order to access the flowers inside may obscure the view of the flowers, thereby making the purchase thereof less likely. Additionally, these types of prior art floral display tend to not be very mobile, thereby limiting the merchandising opportunities for the flowers.

Other prior art floral displays, such as the ones disclosed in U.S. Pat. Nos. 4,551,943, 4,958,461, and 5,146,709 overcome some of these deficiencies, but have other deficiencies themselves. In particular, U.S. Pat. No. 4,958,461 discloses a floral display that is self contained and allows easy visual and physical access to the flowers displayed therein. However, given the fact that the display described in that patent does not include any kind of built-in cooling mechanism, it requires significant attention from an employee. In particular, a water solution must continually be replenished to that display in order to feed the flowers placed therein, which can be messy, inconvenient and time consuming.

U.S. Pat. No. 4,551,943 also discloses a self-contained floral display unit. However, given the way the vases are set-up in that display unit, it can be difficult for consumers to see and access the displayed flowers. Additionally, the flow of cooling liquid to the vases is not as efficient as may be desired in that it uses a “bath” type. Not only is this “bath” type arrangement messy and inconvenient, it requires a substantial amount of fluid to operate effectively. Needless to say, this arrangement requires a substantially larger compressor to cool the fluid which adds to the expense associated with the equipment, both in initial expenditure and operating costs.

U.S. Pat. No. 5,146,709 discloses a floral display case that is self-contained and which allows full 360 degree display of the flowers displayed therein. However, the display described in that patent utilizes not only a complex, relatively inefficient “cascading” cooling system that puts chilled water in direct contact with the flowers being displayed. This system can result in the easy transmission of bacteria in the water bath, and requires frequent cleaning and sterilizing in order to maintain appropriately.

Accordingly, it would be desired to have a self-contained floral display unit which allows 360 degree access to the flowers displayed therein, which efficiently cools water in vases containing the flowers using a closed-loop system, which may or may not be self contained and which may or may not be movable.

### SUMMARY OF THE INVENTION

The present invention provides a floral display unit that enables a consumer easy access and view of flowers displayed therein. The present invention uses a closed-loop cooling system to effectively and efficiently chill vases which contain the displayed flowers. Preferably, the floral display of the present invention allows 360 degree access to the flowers and is completely self-contained. In some preferred embodiments, the liquid used in the closed-loop cooling system is chilled using a compressor contained in the base of the display case. In other preferred embodiments, the cooling system may be located remotely from the display itself. In this embodiment, the display may be connected to the cooling system utilizing liquid flow lines extending from the cooling system to the display system. In a preferred embodiment, the floral display of the present invention is circular in design and includes at least one second-level tier for the display of flowers.

In a preferred embodiment of the floral display of the present invention, the heat transfer between the vase holding the displayed flowers and the cooling system includes a thermally conductive vase liner made from, for example, stainless steel, for receiving a vase to hold the flowers for display. A heat exchanger coil, connected to the cooling system, is preferably wrapped around the vase liner in a manner which provides for efficient heat transfer between the vase liner and the coil. The coil is preferably surrounded in an insulative material, such as foamed urethane, to improve the heat transfer efficiency thereof.

Other embodiments of the invention will be apparent to those of ordinary skill in the art and are considered to be within the scope of the invention.

### BRIEF DESCRIPTION OF THE DRAWINGS

FIG. 1 shows a front perspective view of a floral display in accordance with the present invention;

FIG. 2 shows a top plan view of the floral display of FIG. 1;

FIG. 3 shows a front perspective view of the floral display of FIG. 1;

FIG. 4 shows a side elevational view of the floral display of FIG. 1;

FIG. 5 shows a heat exchanger/vase assembly operative for use in connection with a floral display in accordance with the present invention;

FIG. 6 shows an exploded view of the heat exchanger/vase assembly as shown in FIG. 5; and

FIG. 7 is a schematic depiction of a cooling system operative for use in connection with a floral display in accordance with the present invention.

### DETAILED DESCRIPTION

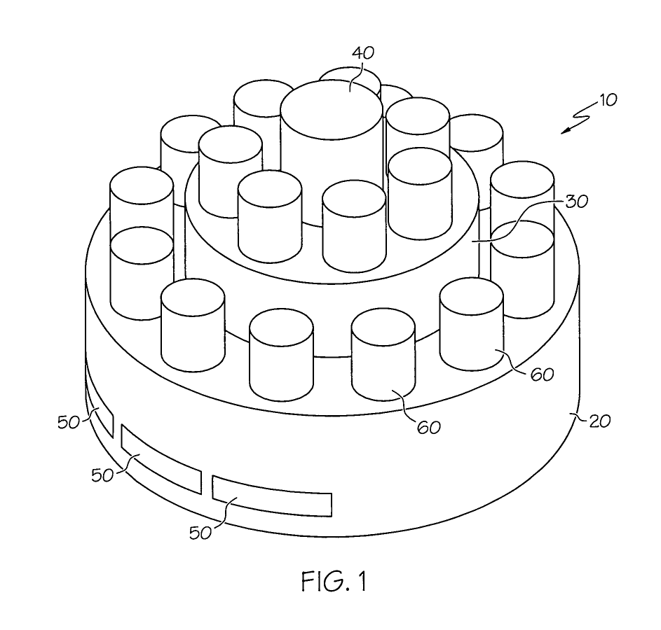

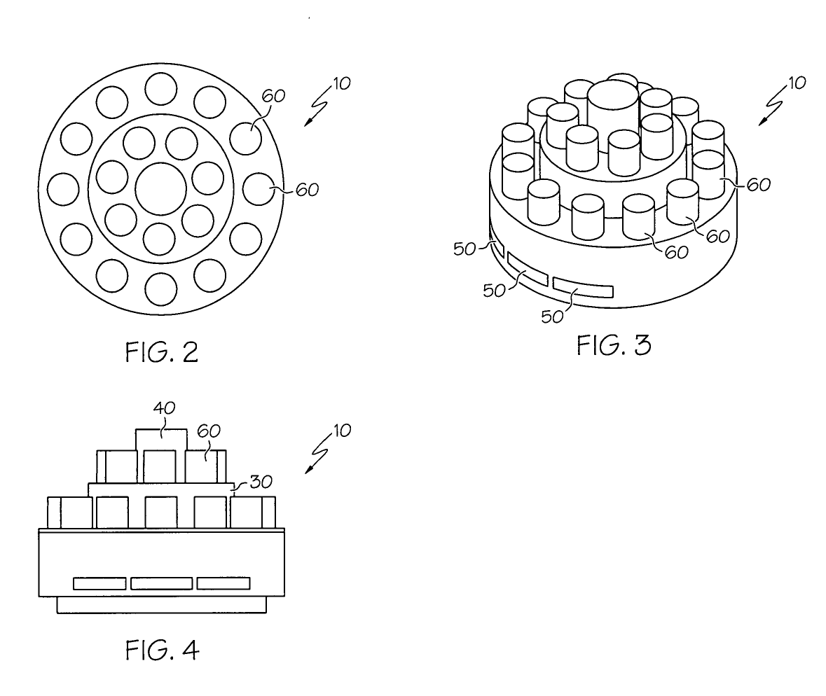

As seen best in FIGS. 1-4, the present invention provides a floral display unit 10 that enables a consumer easy access and view of flowers displayed therein. In an embodiment of the invention, the floral display 10 includes a base portion 20, a second tier 30, and a top display tier 40. The base portion 20 may be circular in design, although any particular geometric configuration is considered operative and within the scope of the invention. In an embodiment of the invention where the cooling system 150 is provided in the base portion 20, the base portion 20 may include venting 50 to allow the flow of air around the cooling system 150 condenser 160. Preferably, the base portion 20 includes discrete heat exchanger assemblies 60, shaped to receive an otherwise standard vase 90, arranged around a peripheral edge of the base portion 20. In a preferred embodiment, the floral display 10 of the present invention is circular in design and includes at least one second-level tier 30 for the display of flowers.

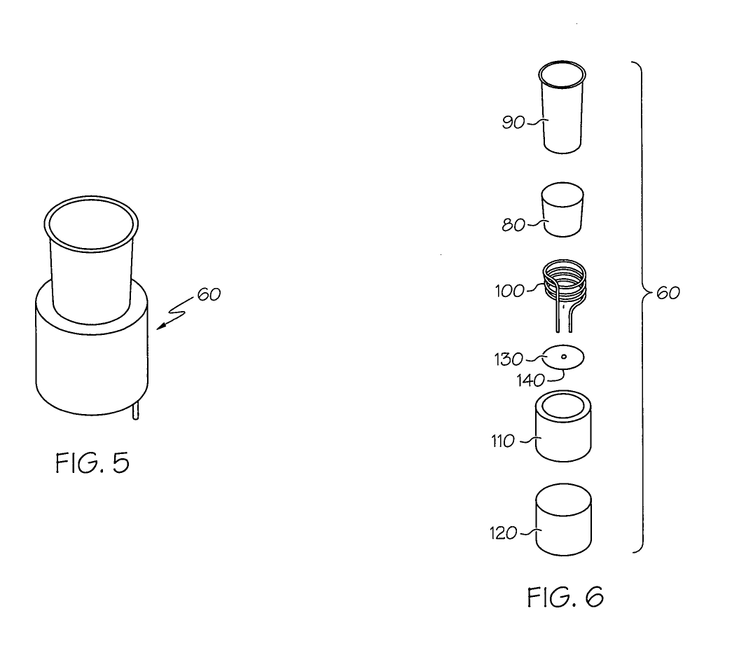

As seen best in FIGS. 5 and 6, discrete heat exchanger assemblies 60 in accordance with the present invention include a vase liner 80 for receiving a vase 90 to hold the flowers (not shown) for display. The vase liner 80 may be made of any suitable thermally conductive material including metals, such as stainless steel. A heat exchanger coil 100, connected to the cooling system 150, is preferably wrapped around, or more preferably, thermally bonded around the vase liner 80 in a manner which provides for efficient heat transfer between the vase liner 80 and the coil 100. The coil 100 is preferably surrounded in an insulative material 110, such as foamed urethane, to improve the heat transfer efficiency thereof. In an embodiment of the invention, the insulative material 110 is surrounded by an outer shell 120. The outer shell 120 may be made of any suitable material including, for example, stainless steel or another corrosion resistant material. In a preferred embodiment the heat exchanger assemblies 60 include a bottom disc 130 that is shaped and sized to collect condensate and has a nipple 140 attached to a condensate collection system (not shown) in order to prevent pooling of condensate at the bottom of the heat exchanger assemblies 60.

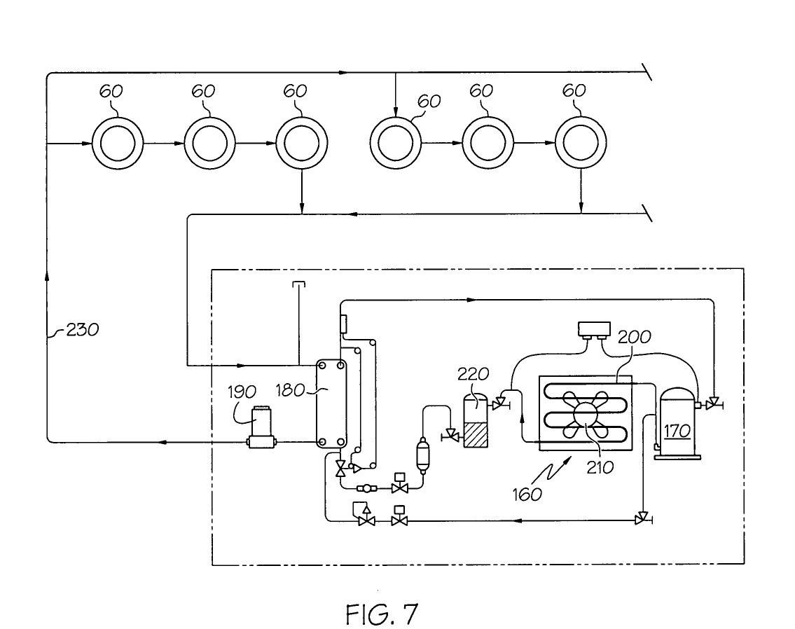

In a preferred embodiment of the invention, a cooling system 150, as best shown schematically in FIG. 7, is provided. The cooling system 150 may be any closed-loop, liquid cooling system as is well-known to those of ordinary skill in the art. As such, the following description is provided is merely an exemplar of a system which is operative in connection with the present invention and is not meant to limit the invention in any manner. In particular, the cooling system 150 may include a condenser 160, a compressor 170, and an evaporator 180. The condenser 160 preferably is comprised of a heat exchanger 200 and a fan 210, and is located adjacent a heat sink (not shown) through air vents 50. The evaporator 180 may be of any type conventionally known in the art including, but not limited to, plate-type, coil-type, fin-type, etc. The evaporator 180 preferably operates as a heat exchanger between a cooling fluid, such as food-grade glycol, and a compressible fluid, such as freon or some other known fluid conventionally used for such purposes. As is well known in the art, the compressible fluid enters the evaporator 180 from a liquid receiver 220 as a liquid. The compressible fluid is evaporated in the evaporator 180, thereby cooling the cooling liquid as desired. The compressible fluid, in the form of evaporated gas, returns to the compressor 170 and, through the condenser 160, is converted back into a liquid where it is received in the liquid receiver 220. The compressible fluid is then returned to the evaporator 180 and the entire process is repeated. After the cooling fluid is cooled in the evaporator 180, it is circulated to the individual heat exchanger assemblies 60 through a closed-loop 230 using the circulator pump 190. These individual heat exchanger assemblies 60 may be connected in straight series, if only a few are being utilized, a modified “daisy chain” series (as shown in FIG. 7), by using a parallel or manifold-type configuration, or by using any other type of connections that are well-known by those of ordinary skill in the art.

Through this process, the heat exchangers 60 are able to cool the floral vases 90 and any fluid located therein, thereby extending the product life of the flowers displayed in the display 10. Preferably, the cooling system 150 as described herein operates to keep the vases 90 and the fluid therein at a steady temperature of approximately 34°-48° F., and more preferably between 36°-38° F. In this manner the product life of the displayed flowers may be extended from approximately 3-4 days to as much as 7-8 days or more. As may be desired, the display 10 may be entirely self-contained, having all of the cooling system 150 located in the base 20 thereof. Alternatively, the cooling system 150 may be located remotely from the base 20 of the display 10, and may be connected only through a portion of the closed-loop 230. The base 20 may be of any desired shape and or size which provides a pleasing display for flowers and which allows access thereto by consumers. Non-limiting examples of shapes considered operative and within the scope of the present invention include circles, ovals, rectangles, trapezoids, parallelograms, stars, hearts, triangles, etc. Also, while the embodiment show includes a two-tier design, it is to be understood that 1 tier, 3 tier, 4 tier, etc. designs are possible and considered within the scope of the invention.

Following from the above description and invention summaries, it should be apparent to those of ordinary skill in the art that, while the methods and apparatuses herein described constitute exemplary embodiments of the present invention, the invention contained herein is not limited to this precise embodiment and that changes may be made to such embodiments without departing from the scope of the invention as defined by the claims. Additionally, it is to be understood that the invention is defined by the claims and it is not intended that any limitations or elements describing the exemplary embodiments set forth herein are to be incorporated into the interpretation of any claim element unless such limitation or element is explicitly stated. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A floral display comprising:
a base;
at least one heat exchanger assembly positioned on said base, said heat exchanger assembly being shaped to receive a floral display therein;
a cooling system in thermal communication with said heat exchanger assembly;
wherein said base is shaped and sized such that a consumer may have three hundred and sixty degree access to said base.

2. The floral display of claim 1 wherein said heat exchanger assembly comprises a vase liner shaped and sized to receive a floral vase therein and further comprises a portion of said cooling system in direct thermal contact with said vase liner.

3. The floral display of claim 2 wherein said portion of said cooling system comprises a coil wrapped around said vase liner.

4. The floral display of claim 3 wherein said coil is thermally bonded to said vase liner.

5. The floral display of claim 1 wherein said cooling system is a closed loop cooling system.

6. The floral display of claim 1 wherein said cooling system is entirely contained in said base.

7. The floral display of claim 1 further comprising at least one tier positioned on said base and at least one heat exchanger assembly being shaped to receive a floral display therein positioned on said tier.

8. The floral display of claim 2 further comprising an insulative material surrounding said coil.

9. The floral display of claim 8 further comprising an outer shell positioned around said insulative material.

10. The floral display of claim 1 wherein said base is circular in shape.

11. The floral display of claim 6 wherein said base includes vents therein.

12. The floral display of claim 3 further comprising a disc positioned at a bottom of said vase liner shaped to collect condensate therein.

13. A floral display comprising:
a base;
at least one heat exchanger assembly positioned on said base, said heat exchanger assembly being shaped to receive a floral display therein, said heat exchanger further comprising a vase liner;
a cooling system in thermal communication with said vase liner, said cooling system being entirely contained in said base;
wherein said base is sized such that a consumer may have three hundred and sixty degree access to said base.

14. The floral display of claim 13 wherein said cooling system is in thermal communication with said vase liner through a coil thermally bonded to said vase liner.

15. The floral display of claim 13 wherein said cooling system is a closed loop cooling system.

16. The floral display of claim 13 further comprising at least one tier positioned on said base and at least one heat exchanger assembly being shaped to receive a floral display therein positioned on said tier.

17. The floral display of claim 13 further comprising an insulative material surrounding said vase liner.

18. The floral display of claim 17 further comprising an outer shell positioned around said insulative material.

19. The floral display of claim 13 wherein said base is circular in shape.

20. A floral display comprising:
a circular base having at least one tier positioned on a top thereof and vents positioned in a lower periphery thereof;
at least one heat exchanger assembly positioned on said base and said tier, said heat exchanger assembly being shaped to receive a floral display therein, said heat exchanger further comprising a vase liner;
a cooling system in thermal communication with said vase liner, said cooling system being entirely contained in said base;
wherein said base is sized such that a consumer may have three hundred and sixty degree access to said base.
